(19) United States
(12) Patent Application Publication
(10) Pub. No.: US 2004/0008668 A1
(43) Pub. Date: Jan. 15, 2004

(54) Method for the transmission of digital data over several data transmission networks, the associated units and associated program

(76) Inventor: Ole Droz, US-Sanford, FL (US)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/418,247

(22) Filed: Apr. 18, 2003

Related U.S. Application Data
(63) Continuation of application No. PCT/DE01/04065, filed on Oct. 26, 2001.

(51) Int. Cl. H04L 12/66

(52) U.S. Cl. 370/352; 370/395.5

(57) ABSTRACT

The present invention relates to a system and method in which user data is initially transmitted to a first network gateway by means of a first data transmission network. The user data is encoded according to a first encoding type. The network gateway feeds the user data into a circuit-switching network without further code conversion. The original encoding type and a second encoding type, permissible in the circuit-switching network, are signaled to the circuit-switching network. The signaling of the first encoding type is transferred by the circuit-switching network to a further network gateway unprocessed. The user data is transmitted in the data transmission network as if encoded by means of the permissible encoding type.

### BACKGROUND OF THE INVENTION

The invention relates to a method by which digital user data is, initially, transmitted in a first data transmission network, to a first gateway unit. The user data transmitted into this first data transmission network is encoded in accordance with a first type of encoding. The gateway unit forwards the user data into a circuit-switched network, in which the user data is switched into time slots.

Examples of digital user data are voice data, video data or program data. An example of the first data transmission network could be a data network, in which the data packets are forwarded. Normally, a data packet contains an address part and a user data part. As an example, the contents of the address part might specify a destination address and a sender address. The destination address is used to forward the data packets. A typical protocol used for forwarding data is the internet protocol. In ATM (Asynchronous Transfer Mode) networks the data packets are called cells, and in them is stored so-called path and channel data, used in forwarding them.

An example of a first encoding type is encoding in accordance with the Standard G.723.1 “Dual Rate Speech Coder Multimedia Communications Transmitting at 5.3 and 6.3 Kilobit per Second” from the ITU-T (International Telecommunication Union—Telecommunication Standardization Sector). However, it is also possible to use a different type of encoding in the first data transmission network, for example encoding in accordance with G.726.

In the circuit-switched network there is also a connection set-up phase at lower protocol levels, in which the resources of the network, namely transmission channels, are seized for the connection. Different transmission channels are connected together in such a way as to produce a link between two subscribers. The digital data is then forwarded into transmission channels. This is done by synchronous data transmission, with a prescribed number of items of digital data being transmitted within fixed time intervals, e.g. every 125 μs. In the connection release phase, the resources which had been seized are released again, so that the transmission channels are disconnected from each other again.

Examples of gateway units are shown in the standard H.323 (02/98) “Packet Based Multimedia Communications Systems” from the ITU-T. The term gateway is used in this standard to mean a network interface unit. The gateway terminates the signaling at each end, i.e. for two fixed prescribed protocols. For example, on the packet network side the signaling could be in accordance with the protocol H.323.

According to the standard, only certain types of encoding are provided for; for the ISUP protocol (ISDN-User Part) these are defined in the standard Q.765 section 3.5.4. This type of encoding is coded in a parameter called the “Transmission Medium Requirement”. Essentially, provision is only made for two types of encoding, namely the “voice” coding type, underlying which is a coding in accordance with the standard G.711, and the coding type “64 Kilobit per second unrestricted” However, in the first data transmission network a different type of coding is generally used. Consequently code conversion operations are necessary in the gateway. This code conversion requires circuit units, and needs computation time. In addition, the quality of the user data stream is impaired by the code conversion. In some cases, more bandwidth is also used for transmission in the circuit-switched network that would actually be necessary.

### SUMMARY OF THE INVENTION

An advantage of the present invention is to specify a simple method for the transmission of digital data over a plurality of data transmission networks which, in particular, makes it possible to transmit the user data with high quality levels, with low circuit technology costs and/or with low transmission capacity. It is intended in addition to specify the associated units and an associated program.

The invention arises from the consideration that switching centers used in the circuit-switched network expect signaling in accordance with a standardized signaling protocol, in which only certain types of encoding are permissible. Deviations from this protocol lead to errors and are thus impossible. On the other hand, the user data can only be transmitted with a high quality level if the initial type of encoding is also used in disseminating the user data in the circuit-switched data transmission network.

For this reason, in addition to the procedural steps for the first gateway, mentioned in the introductory remarks, which conform to the signaling protocol specified for the circuit-switched data transmission network, the method according to this invention signals that for the user data use is made of a second coding type, supplementary to and differing from the first coding type. In addition however, the first gateway unit also signals the first coding type to the circuit-switched data transmission network. With the method according to this invention, the user data in the circuit-switched transmission network, coded in accordance with the first coding type, is communicated to a second gateway unit or a terminal device on the circuit-switched network. The circuit-switched network forwards the signaling relating to this second coding type to the terminal device or the second gateway unit, together with signals using the first coding type, which are permissible according to the signaling protocol for the circuit-switched network.

These measures do not necessitate any changes to the switching centers in the circuit-switched network. The switching centers operate in accordance with the signaling protocols specified for them. The signals relating to the first coding type are forwarded essentially unprocessed. This type of forwarding is also referred to as ‘tunneling’. There are several possibilities for tunneling in a switched-circuit network.

By forwarding both coding types to the terminal device or the second gateway unit, the terminal device or gateway unit is put in a position to assign again the correct coding type to the user data when it is decoded. The second coding type must already have been communicated to the second gateway unit or the terminal device in accordance with the signaling protocol for the switched-circuit network. The communication of a second coding type which differs from the first coding type makes it possible for the terminal device or the gateway unit to detect an inconsistency between the coding types specified. If such an inconsistency arises, then the first coding type will automatically be defined as the valid one for subsequent processing.

Under the method according to this invention, the user data will thus be transmitted through the switched-circuit network in accordance with the first coding type. In this process, the user data will be communicated as though it were encoded in accordance with the second coding type. As already mentioned, this does not require the switching centers in the circuit-switched network to be modified specially to adapt them for the method according to this invention. Furthermore, no code conversion is required for the user data. This increases the quality of the transmission, which is considered particularly important for the transmission of voice data. In addition, no circuit elements are required or called on for code conversion. If the transmission rate under the first coding type is lower than the defined data rate for the circuit-switched network, then the transmission rate required in the circuit-switched network will also be lower. The transmission rate thus freed up can be used by other methods.

In a development, a method provided in the signaling protocol of the circuit-switched network, for tunneling signaling messages from outside the network, is used to signal the first coding type. Methods of this sort are known to various circuit-switched networks, for example in circuit-switched networks used in Europe, in the USA and in Japan. In the development, tunneling is used to send the specification of a coding type, which applies to the user data transmitted in the circuit-switched network. This is therefore not a non-network signaling message. However, because the first coding type cannot be directly processed by the circuit-switched network, the specification of the first coding type is tunneled as a non-network signaling message.

In a further development, the signaling protocol is the ISUP protocol (ISDN-User Part). This protocol is defined in the following standards or in a standard which replaces them:

Q.761 (21/99) “Signaling System No. 7—ISDN-User Part Functional Description”,

Q.763 (1997) “Signaling System No. 7—ISDN-User Part Formats and Codes”, and

Q.764 (09/97) “Signaling System No. 7—ISDN-User Part Signaling Procedures”.

The standards cited form the core of the ISUP protocol. According to the ISUP protocol, the second signaling method is transmitted in the TMR parameter (“Transmission Medium Requirement”) which is, for example, contained in an initial address message. Such an initial address message will also be referred to as an IAM.

With the development, the first signaling method will be signaled in accordance with the standard Q.763 Add. 1 and/or Q.765, or in a way similar to a standard based on this standard, e.g. similar to the way defined by the standard Q.765.5. Addendum 1 to standard Q.763 (06/00) specifies a transport element APP (Application Transport Parameter), which is suitable for tunneling. Standard Q.765 defines a general transport method, which can be used for tunneling non-network signaling messages. The transport mechanism defines only the nature of the tunnel, but not the content of the tunneled element.

With another development, the first coding type is signaled in a signaling element which was originally defined for signaling in the circuit-switched network when the user data to which the signaling relates is transmitted over a network other than the circuit-switched network. In this connection, standard Q.765 speaks of Bearer Association Transport (BAT). Use can be made of the signaling element “Single Codec”, which is defined in standard Q.765.5, section 11.1.7 and in the following sub-sections. The standard Q.765.5 was originally for signaling in a circuit-switched network where the user data is transmitted in a so-called backbone network. An example of this backbone network is the Asynchronous Transfer Mode (ATM) network. This is evidently the objective towards which the standard Q.765.5 is directed, from its reference to the standard Q.1901 (2000) “Bearer Independent Call Control Protocol”. With the development, this signaling element is on the other hand also used, without regard for its original purpose, in the case of the signaling in the switched-circuit network for the transmission of user data in the switched-circuit network. This approach permits equivalent programs or subroutines to be used, for example, in the context of the BICC procedure (Bearer Independent Call Control) and with the development of the procedure according to this invention.

With another development of the procedure according to this invention, the user data in the circuit-switched network is communicated to a second gateway unit. This second gateway unit is a gateway to the first data transmission network or to a third data transmission network. As an example, the first and/or third data transmission network might be the internet. Using the circuit-switched data transmission network, voice data for a video conference could, for example, be transmitted with a high quality level. The video data for the video conference could, on the other hand, be transmitted exclusively over the internet, with a lower transmission quality. The second gateway unit does not process the signals relating to the second coding type in accordance with the protocol, because it detects the inconsistency between the first and second coding types. However, the second gateway unit takes the first coding type, which is signaled to it, as the basis for the subsequent processing of the incoming user data. By this means, the second gateway unit is able to avoid the need for another code conversion. This has the effect that the technical consequences in terms of code conversion, identified above for the first gateway unit, also apply for the second gateway unit. The development thus avoids the need for code conversion to be performed twice.

With the next development, the first and/or third data transmission networks are packet transmission networks, in which the user data is transmitted in data packets, which are forwarded in accordance with destination information contained in the data packet. In this case, the first data transmission network or the third data transmission network, as applicable, is a network which works in accordance with the internet protocol, or an ATM network (Asynchronous Transfer Mode).

In another development, the first gateway unit routes user data with various items of destination data and/or for different applications into a common transmission channel of the circuit-switched network. This measure enables the transmission channels of the circuit-switched network to be filled up to their prescribed capacity. The circuit-switched network does not need to know anything about the nature of the user data. For example, this could be used to achieve good utilization of the transmission channels between two company sites or between network operators.

The invention relates, in addition, to a gateway unit used as the first and/or second gateway. In the case of developments, the gateway unit is so constructed that in operation it executes the method in accordance with the invention, or one of its developments. This has the effect that the technical consequences, identified above, also apply for the gateway unit.

The invention also relates to a control unit for a gateway unit which, with the method in accordance with this invention or one of its developments, is used as the first or second gateway unit. The technical consequences mentioned above also apply here.

The invention also relates to a program with an instruction sequence which, when executed by a processor, carries out the method in accordance with the invention or one of its developments, or which when executed effects the functions of a unit which conforms to this invention or a development of such a unit. Hence, the technical consequences identified above also carry over to the program.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts a data transmission link which begins from the internet, has a section in a circuit-switched network, and then terminates again in the internet;

FIG. 2 depicts the structure of a data element for signaling the coding type actually used;

FIG. 3 depicts an IAM message conforming to ISUP, with a data field for specifying an auxiliary coding type, which is not used for encoding the user data, and

FIG. 4 depicts the structure of a code element for naming the call instance in accordance with ISUP.

### DETAILED DESCRIPTION OF THE INVENTION

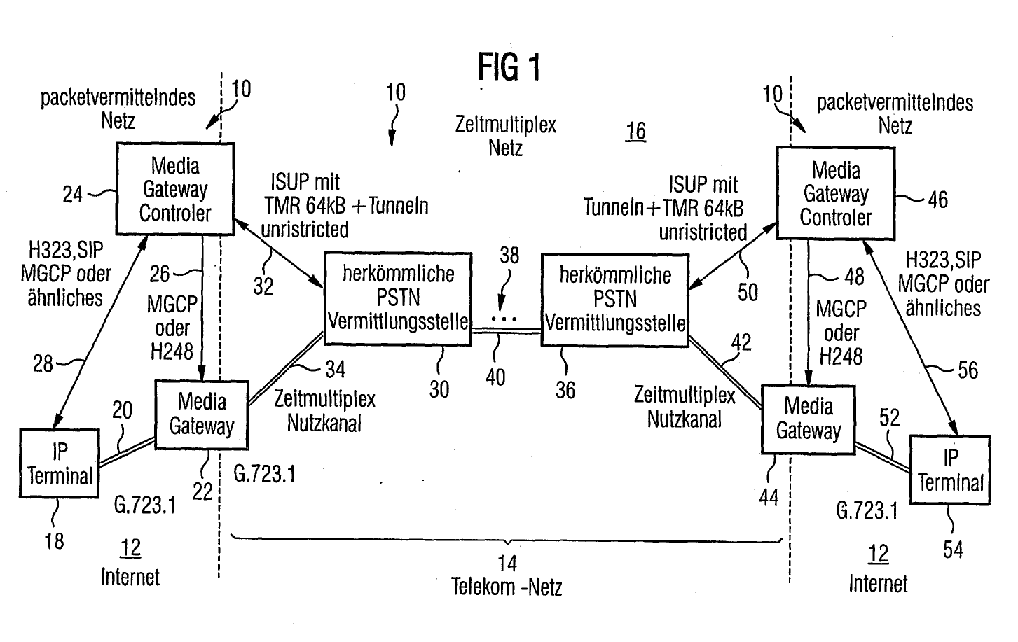

FIG. 1 depicts a data transmission link 10, which begins at the internet 12, which has a section 14 in a circuit-switched telephone network 16 and which then terminates again in the internet 12. Section 14 may typically have a length of several hundred kilometers. The data transmission link 10 is used for the transmission of voice data. This voice data is encoded in accordance with the ITU-T standard G.723.1.

In the internet 12, the data is transmitted in accordance with the TCP/IP protocol (Transmission Control Protocol/Internet Protocol), which has been defined by the IETF (Internet Engineering Task Force). The telephone network 16 is a network in which the user data is transmitted in transmission channels. These transmission channels are produced by using a time-multiplexing procedure for the transmission. An example of this telephone network is Deutsche Telekom AG's telephone network.

The user data is created by an IP terminal device 18, which contains a voice data processing unit, which converts speech from the user of IP terminal device 18 into data, and outputs voice data audibly for that user. The user data emitted by terminal device 18 is transmitted in data packets over the transmission link 20 to a gateway unit 22. Gateway unit 22 forms the interface between the internet 12 and the telephone network 16, and is controlled by a control unit 24, see arrow 26. In controlling the gateway unit 22, the control unit 24 applies a prescribed protocol, e.g. the MGCP protocol (Media Gateway Control Protocol), which has been defined by the IETF in the de facto standard RFC 2705 (Request for Comment). Alternatively, use may be made of the protocol defined in the standard H.248, which has been drawn up by the ITU.

Signaling messages are exchanged between the terminal device 18 and the control unit 24, see arrow 28. In this exchange of signaling messages, a prescribed signaling protocol is again observed, e.g. the MGCP protocol, the protocol conforming to the ITU-T's standard H.323, or a protocol called the SIP (Session Invocation Protocol). On the other hand, control unit 24 also exchanges signaling messages with a switching center 30 in the telephone network, see arrow 32. The ISUP protocol is used for signaling between the control unit 24 and the switching center 30. Switching center 30 could typically be an EWSD switching center (digital electronic switching system) from Siemens AG. For the transmission of the user data from the gateway unit 22 to the switching center 30, use is made of a PCM-30 link (Pulse Code Modulation), 34, which transmits thirty user channels.

In the telephone network 16, the user data is transmitted from switching center 30 to a switching center 36, which has the same design as switching center 30. Switching centers 38 which lie between the switching centers 30 are indicated by dots. For the transmission of user data between the switching centers 30 and 36, use is made of a PCM-30 link 40, which is connected through the other switching centers 38.

From switching center 36 onward, the user data is forwarded via a PCM-30 link 42 to a gateway unit 44, which also forms an interface between the telephone network 16 and the internet 12. Gateway unit 44 is controlled by a control unit 46. In exercising control, it applies the MGCP protocol already mentioned, or the ITU-T's H.248 protocol, see arrow 48. Between the switching center 36 and the control unit 46, a signaling link 50 is used, on which the signaling is in accordance with the ISUP protocol.

The user data received via the PCM-30 link 42 is forwarded by gateway unit 44 in data packets, via a transmission link 52 to an IP terminal device 54 (internet protocol) on the internet 12. In transmitting the user data via the transmission link 52, the TCP/IP protocol is again used. A prescribed signaling protocol is used for signaling between the IP terminal device 54 and the gateway unit 46, see arrow 56. This allows the H.323 protocol, the MGCP protocol or the SIP protocol to be used.

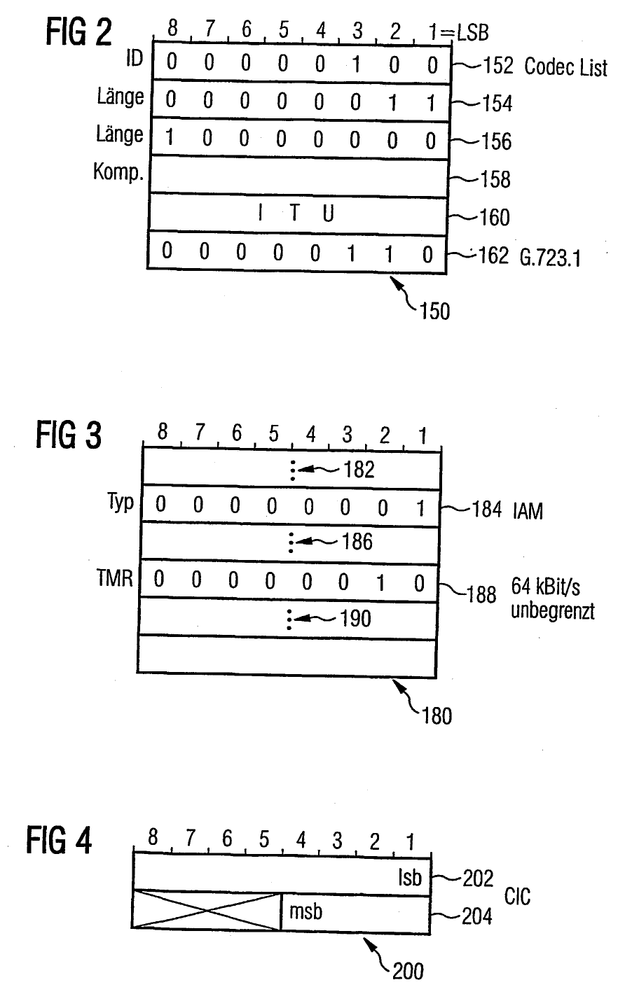

The user data undergoes no code conversion in gateway unit 22, so that data in the telephone network 16, encoded in accordance with the standard G.723.1, will also be communicated. Similarly, the coding type for the user data is not changed in gateway unit 44. To make this possible, the control unit 24 signals to the gateway unit 22 that no code conversion should take place. In addition, the ISUP protocol is used to signal to the switching center 30 that the user data is being transmitted in accordance with the coding type “64 Kilobit per second unrestricted”, although this is actually not the case. However, this auxiliary signaling enables the ISUP protocol to be satisfied. In addition, the control unit 24 signals, in a data element which is explained below by reference to FIG. 2, that the user data is encoded in accordance with the standard G.723.1. For the transmission of this data element, use is made of procedures conforming to the standard Q.763 Add. 1, Q.765 and a procedure similar to that according to the standard Q.765.5. Switching centers 30, 38 and 36 forward the data element unprocessed, in accordance with ISUP, through to gateway unit 46. Switching centers 30, 38 and 36 communicate the user data as though it were encoded using the coding type “64 Kilobit per second unrestricted”.

The control unit 46 receives the signaling relating to the coding type, in accordance with the ISUP protocol. The value signaled is “64 Kilobit per second unrestricted”. At the same time, the gateway unit 46 receives the data element explained below by reference to FIG. 2, and determines that it specifies the coding type G.723.1. On the basis of this inconsistency, coding type G.723.1 is recognized as the one with which the user data, arriving from the telephone network 16, is actually encoded. Control unit 46 signals to the gateway unit 44 that the user data arriving via the PCM-30 link 42 requires no code conversion before it is forwarded over the transmission link 52.

The procedures explained by reference to FIG. 1 for transmissions in the direction from terminal device 18 to terminal device 54 are carried out in a similar way for transmissions in the reverse direction, i.e. for user data transmitted from terminal device 54 to terminal device 18. The units and transmission links shown in FIG. 1 are also used for transmissions in the reverse direction.

FIG. 2 shows the structure of a data element 150 for tunneling a value, specifying the coding type actually used for encoding the user data, through the telephone network 16. Data element 150 contains, for example, six consecutive data fields, 152 to 162, each of which has a length of eight bits, i.e. one byte. Bit positions 1 to 8 in this sequence are counted from right to left. An identifier ID with the value three is transmitted in data field 152, to indicate that a coding type list is to be transmitted, see the standard Q.765, section 11.1.2.

Data fields 154 and 156 specify the number of data fields, 158 to 162, which follow data fields 154, 156 in the data element 150. In the exemplary embodiment, the value three encoded in binary format is stored in data fields 154 and 156, see the standard Q.765.5, section 11.1.1. Data field 158 is used to transmit an item of compatibility data, the value of which shows the receiver what should be done if it cannot process data element 150 in full, see standard Q.765.5, section 11.1.1.

Data field 160 specifies the ITU organization (International Telecommunication Union) as the organization which defined the coding type whose designation follows. In the next-following data field, 162, the value six is specified, encoded in binary format, to identify the coding type in accordance with the standard G.723.1, see standard Q.765.5, section 11.1.7.2.1.1.

FIG. 3 shows an IAM message 180, which is sent from the gateway unit 24 to switching center 30. The initial data fields 182 defined in the standard Q.763 are indicated by dots. In a data field 184, the type of the message 180 is specified as the value one, which is defined by standard Q.763 as the value for an IAM message. Further data fields 186 between data field 184 and a subsequent data field 188 are indicated by dots. Data field 188 is used to store a parameter called the TMR (Transmission Medium Requirement), which in the exemplary embodiment has the value two. The value two identifies the coding type as “64 Kilobit per second unrestricted”. Further data fields 190 in the IAM message 180 are indicated by dots.

FIG. 4 shows the structure of a code element 200, which is also called the CIC (Call Instance Code), cf. standard Q.763, section 9.1. Code element 200 is used for designating instances of calls between the switching centers 30, 38 and 36. These call instances are ultimately, transmission channels on the PCM-30 links. Control units 24 and 46 also use code element 200 through to the telephone network 16.

Code element 200 contains two data fields, 202 and 204, each with a length of one byte. The number of the call instance is transmitted starting with the least significant bit in data field 202, see bit position 1, through to bit position 8 of data field 202 and then continuing between bit positions 1 and 4 of data field 204. Bit positions 4 to 7 of data field 204 are not used in designating the call instance. No further data fields are necessary for designating the call instance.

In the claims:

1. A method for transmitting data over a plurality of data transmission networks, comprising the steps of:
transmitting data from a first transmission network to a first gateway unit, said data having a first type of encoding;
forwarding user data to a circuit switched data transmission network from said first gateway unit, said user data being communicated in time slots;
signaling from said first gateway unit a second coding type for said user data, said second coding type being in accordance with a signaling protocol prescribed for said circuit-switched data transmission network;
signaling from said first gateway said first coding type to said circuit-switched data transmission network;
communicating said user data, encoded in accordance with said first coding type, from said circuit-switched data transmission network to a second gateway unit or to a terminal device of the circuit-switched network; and
forwarding said signaling relating to said second coding type to said second gateway or said terminal device together with signaling, permissible according to the signaling protocol, for the first coding type.

2. The method according to claim 1, further comprising the step of using a procedure provided for in said signaling protocol for tunneling non-network signaling messages.

3. The method according to claim 1, wherein:
said signaling protocol is an ISUP protocol;
said second coding type is signaled in a parameter Transmission Medium Requirement; and
said first signaling type is signaled in accordance with standards Q.763 Add. 1 and Q.765 and Q.765.5 or with a standard which is based on one of these standards.

4. The method according to claim 3, wherein said first coding type is signaled in a signaling element which was originally defined for signaling in a circuit-switched network wherein user data to which signals relate is transmitted separately over a network other than the circuit-switched network.

5. The method according to claim 4, wherein said signaling element comprises signaling element APP conforming to the standard Q.763 Add. 1.

6. The method according to claim 4, wherein said signaling element comprises an original function defined according to said Q.765.5 standard.

7. The method according to claim 6, wherein said function comprises specifying coding type of user data which is transmitted over a data transmission network other than said circuit-switched data transmission network.

8. The method according to claim 1, wherein:
said signaling protocol is an ISUP protocol;
said second coding type is signaled in a parameter Transmission Medium Requirement; and
said first signaling type is signaled in accordance with standards Q.763 Add. 1 or Q.765 or Q.765.5 or with a standard which is based on one of these standards.

9. The method according to claim 8, wherein said first coding type is signaled in a signaling element which was originally defined for signaling in a circuit-switched network wherein user data to which signals relate is transmitted separately over a network other than said circuit-switched network and preferably per signaling element APP conforming to standard Q.763 Add. 1.

10. The method according to claim 9, wherein said signaling element originally had a function defined in the standard Q.765.5.

11. The method according to claim 10, wherein said function comprises specifying a coding type of user data which is transmitted over a data transmission network other than said circuit-switched data transmission network.

12. The method according to claim 1, further comprising the steps of communicating said user data in said circuit-switched data transmission network to a second gateway unit, said second gateway unit connecting said circuit switched data transmission network to said first data transmission network or to a third data transmission network, said second gateway unit not processing said signaling relating to said second coding type in accordance with said protocol, and said second gateway basing its further processing of incoming user data on a first coding type which is signaled to it.

13. The method according to claim 1, wherein said first data transmission network and said third data transmission network and packet transmission network, wherein user data is transmitted in data packets which are forwarded in accordance with destination information contained in said data packet, and wherein said first data transmission network and said third data transmission network are data networks operating in accordance with an internet protocol or an ATM network.

14. The method according to claim 1, wherein said first data transmission network or said third data transmission network is a packet transmission network, wherein user data is transmitted in data packets which are forwarded in accordance with destination information contained in said data packet, or wherein said first data transmission network or said third data transmission network is a data network operating in accordance with an internet protocol or an ATM network.

15. The method according to claim 1, wherein said first coding type is a coding type other than coding types permitted by ISUP protocol and said second coding type is a coding type permitted by said ISUP protocol.

16. The method according to claim 1, further comprising the step of forwarding data with various destination information and data for different applications on a common transmission channel, in said circuit switched network, from said first gateway unit.

17. The method according to claim 1, further comprising the step of forwarding data with various destination information or data for different applications on a common transmission channel, in said circuit switched network, from said first gateway unit.

18. A gateway unit, comprising:
a user data transmission interface to a circuit-switched data transmission network in which user data is communicated in time slots;
a user data transmission interface to another data transmission network;
a control unit facilitating forwarding of user data, arriving from said another data transmission network, into said circuit-switched data transmission network with a coding in accordance with a first coding type differing from permitted coding types of said circuit-switched transmission network; and
said control unit further facilitating receipt of user data from said circuit-switched transmission network, said user data comprising a coding in accordance with said first coding type.

19. The gateway unit according to claim 18, further comprising means for:
transmitting data from a first transmission network to a first gateway unit, said data having a first type of encoding;
forwarding user data to a circuit switched data transmission network from said first gateway unit, said user data being communicated in time slots;
signaling from said first gateway unit a second coding type for said user data, said second coding type being in accordance with a signaling protocol prescribed for said circuit-switched data transmission network;
signaling from said first gateway said first coding type to said circuit-switched data transmission network;
communicating said user data, encoded in accordance with said first coding type, from said circuit-switched data transmission network to a second gateway unit or to a terminal device of the circuit-switched network; and
forwarding said signaling relating to said second coding type to said second gateway or said terminal device together with signaling, permissible according to the signaling protocol, for the first coding type.

20. A control unit for a gateway unit, said gateway unit comprising a signaling interface to a circuit-switched data transmission network wherein user data is communicated in time slots and said network including a signaling interface to another data transmission network, said control unit comprising:
means for exercising control over a gateway unit such that user data arriving from a data transmission network is forwarded into a circuit-switched data transmission network with a coding in accordance with a coding type which differs from coding types permissible under said circuit-switched data transmission network signaling protocol; and
means for signaling to said circuit-switched data transmission network said first and a second coding type, said second coding type being permitted in said circuit-switched data transmission network.

21. A control unit for a gateway unit, said control unit comprising a signaling interface to a circuit-switched data transmission network wherein user data is communicated in time slots and said network including a signaling interface to another data transmission network, said control unit comprising:
means for controlling said gateway unit such that user data arriving from said circuit-switched data transmission network may be received when encoded in accordance with a coding type which differs from coding types permissible in accordance with a signaling protocol for said circuit-switched data transmission network;
means for selecting for use, in further processing data to which said signaling relates, a coding type which is not permitted in said circuit-switched network upon receipt of signaling messages comprising two different coding types.

22 The control unit according to claim 20, further comprising means for:
transmitting data from a first transmission network to a first gateway unit, said data having a first type of encoding;
forwarding user data to a circuit switched data transmission network from said first gateway unit, said user data being communicated in time slots;
signaling from said first gateway unit a second coding type for said user data, said second coding type being in accordance with a signaling protocol prescribed for said circuit-switched data transmission network;
signaling from said first gateway said first coding type to said circuit-switched data transmission network;
communicating said user data, encoded in accordance with said first coding type, from said circuit-switched data transmission network to a second gateway unit or to a terminal device of the circuit-switched network; and
forwarding said signaling relating to said second coding type to said second gateway or said terminal device together with signaling, permissible according to the signaling protocol, for the first coding type.

23. The control unit according to claim 21, further comprising means for:
transmitting data from a first transmission network to a first gateway unit, said data having a first type of encoding;
forwarding user data to a circuit switched data transmission network from said first gateway unit, said user data being communicated in time slots;
signaling from said first gateway unit a second coding type for said user data, said second coding type being in accordance with a signaling protocol prescribed for said circuit-switched data transmission network;
signaling from said first gateway said first coding type to said circuit-switched data transmission network;
communicating said user data, encoded in accordance with said first coding type, from said circuit-switched data transmission network to a second gateway unit or to a terminal device of the circuit-switched network; and
forwarding said signaling relating to said second coding type to said second gateway or said terminal device together with signaling, permissible according to the signaling protocol, for the first coding type.

24. A computerized method for transmitting data over a plurality of data transmission networks, comprising a computer program facilitating performance of the steps of:
transmitting data from a first transmission network to a first gateway unit, said data having a first type of encoding;
forwarding user data to a circuit switched data transmission network from said first gateway unit, said user data being communicated in time slots;
signaling from said first gateway unit a second coding type for said user data, said second coding type being in accordance with a signaling protocol prescribed for said circuit-switched data transmission network;
signaling from said first gateway said first coding type to said circuit-switched data transmission network;
communicating said user data, encoded in accordance with said first coding type, from said circuit-switched data transmission network to a second gateway unit or to a terminal device of the circuit-switched network; and
forwarding said signaling relating to said second coding type to said second gateway or said terminal device together with signaling, permissible according to the signaling protocol, for the first coding type.
